(19) United States
(12) Patent Application Publication
(10) Pub. No.: US 2025/0205599 A1
(43) Pub. Date: Jun. 26, 2025

(54) HIGH FIDELITY MIXED REALITY SYSTEM FOR MANAGING PHANTOM PAIN

(71) Applicants: The United States Government as represented by the Department of Veterans Affairs, Washington, DC (US); BOARD OF REGENTS, THE UNIVERSITY OF TEXAS SYSTEM, Austin, TX (US)

(72) Inventors: Thiru Annaswamy, Dallas, TX (US); Balakrishnan Prabhakaran, Dallas, TX (US); Yu-yen Chung, Dallas, TX (US)

(21) Appl. No.: 18/852,934

(22) PCT Filed: Mar. 30, 2023
(86) PCT No.: PCT/US2023/016931

§ 371 Date: Sep. 30, 2024

Related U.S. Application Data
(60) Provisional application No. 63/325,410, filed on Mar. 30, 2022.

(51) Int. Cl. A63F 13/55; A63F 13/428; A63F 13/52; G02B 27/01; G06T 13/40; G06T 19/00; G06T 19/20

(52) U.S. Cl. CPC A63F 13/55; A63F 13/428; A63F 13/52; G02B 27/017; G06T 13/40; G06T 19/006; G06T 19/20; G06T 2219/2004

(57) ABSTRACT

Methods, systems, and apparatuses are described for outputting a personalized humanoid avatar of a subject within a virtual environment to assist in the management of phantom limb pain in patients with limb amputations. Motion data associated with one or more motions of at least one intact limb of the subject may be received from a sensor. The motion data may be applied to an intact representation of a subject's amputated limb of the subject's avatar.

### CROSS REFERENCE TO RELATED PATENT APPLICATION

This application claims priority to U.S. Provisional Application No. 63/325,410, filed Mar. 30, 2022, which is herein incorporated by reference in its entirety.

### BACKGROUND

Virtual reality (VR) refers to a computer-generated environment which users may experience with their physical senses and perception. VR has countless applications in myriad industries ranging from entertainment and gaming to engineering and medical science. For example, virtual environments can be the setting for interacting with a personalized avatar or a simulated surgery. VR experiences are rendered so as to be perceived by physical sensing modalities such as visual, auditory, haptic, somatosensory, and/or olfactory senses. In a similar vein, augmented reality (AR) refers to a hybrid environment which incorporates elements of the real, physical world as well as elements of a virtual world. Like VR, AR has countless applications across many different industries. The complementary nature of AR makes it well-suited to applications such as gaming, engineering, medical sciences, tourism, recreation and the like. Mixed reality (MR) is the next step in computer-generated environment which may combine both VR and AR experiences. With the advent of RGB-D cameras such as the Microsoft Kinect, MR systems and applications have incorporated “live” 3D human models, such as personalized humanoid avatars. Such “live” 3D human models give users a better sense of immersion as they see details such as the dress the human is wearing, their facial emotions, etc. MR games, utilizing these “live” 3D human models have been used to create an in-home serious game to treat subjects suffering from phantom limb pain. Phantom limb pain is typically felt after amputation (or even paralysis) of limbs. Such phantom limb pains that patients may experience include vivid sensations from the missing body part such as frozen movement or extreme pain. For intervention, mirror therapy shows that perceptual exercise such as mirror box may help the patient's brain to re-visualize movements of the limb that is paralyzed or amputated.

A system with a single camera (typically, in the front) is the most suitable for use in MR games deployed in homes for treating phantom limb pain, considering the ease of setting up the system. However, such in-home settings bring up several challenges as the position of the RGB-D camera might be at different heights and orientations based on available furniture and space. In these MR games, different perspectives of rendering can be applied. If the perspective in the game is not well aligned with the front camera, the visual rendering for users require tight integration of a user's “live” model and texture. Furthermore, conventional systems do not have a means for producing a personalized humanoid avatar of a subject that includes a 3D graphical illusion of an intact depiction of an amputated limb within a virtual world that efficiently calibrates for the multiple possible rendering perspectives with respect to the personalized humanoid avatar.

### SUMMARY

It is understood that both the following general description and the following detailed description are exemplary and explanatory only and are not restrictive.

Methods, systems, and apparatuses are described for rendering a personalized humanoid avatar within a virtual environment to assist in the management of phantom limb pain. The mixed reality scene may comprise the personalized humanoid avatar within the virtual environment. A MR device may comprise one or more sensors which may determine one or more of a position, orientation, location, and/or motion of the subject within the virtual environment.

In an embodiment, are methods comprising performing, based on receiving calibration data from a sensor, a real-time camera-to-skeletal pose and a real-time floor calibration to estimate a floor plane of an environment detected in calibration data, wherein the sensor comprises a RGB-D camera, causing a display to output a user interface within a virtual environment, wherein the user interface includes a gaming session control menu, wherein the gaming sessions control menu includes an option to output a game to a user to engage the user to move at least one intact extremity, causing the display, based on the calibration, to output a personalized humanoid avatar of the user within the virtual environment, wherein the personalized humanoid avatar includes an intact extremity representation of an amputated extremity of the user, wherein the intact extremity representation of the amputated extremity comprises a representation of an intact extremity of the user opposite of the amputated extremity, receiving, from the sensor, real-time motion data of user movements associated with the game, wherein the real-time motion data includes motion data associated with movements of the at least one intact extremity, applying the real-time motion data to the personalized humanoid avatar including applying a motion to the intact extremity representation of the amputated extremity based on the real-time motion data associated with movements of the at least one intact extremity, and sending, to a server, user feedback comprising the real-time motion data of the user movements associated with the game, wherein the server stores the user feedback in a database associated with the user.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of the present description serve to explain the principles of the methods and systems described herein. To easily identify the discussion of any particular element or act, the most significant digit or digits in a reference number may refer to the figure number in which that element is first introduced.

FIG. 1 shows an example system;

FIG. 2 shows an example system architecture;

FIG. 3 shows an example system;

FIGS. 4A-4C show an example scene;

FIGS. 5A-5C show an example scene;

FIG. 6 shows an example process; and

FIG. 7 shows an example headset device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the present methods and systems may take the form of a computer program product on a computer-readable storage medium (e.g., non-transitory) having processor-executable instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These processor-executable instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These processor-executable instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the terms “user,” or “subject,” may indicate a person who uses an electronic device or a device (e.g., an artificial intelligence electronic device) that uses an electronic device.

Methods and systems are described for generating a personalized humanoid avatar of a subject within a virtual environment to assist in the management of phantom limb pain. A MR device may comprise, or be in communication with, a camera, which may be, for example, any imaging, or image capture, device such as a RGB-D camera, a digital camera, and/or digital video camera. Throughout the specification, reference may be made to MR or an MR device. It is to be understand that MR, AR, and VR may be used interchangeably and refer to the same circumstances or devices. The camera may be associated with a field of view (e.g., a frame) representing an extent of the observable world that the camera may image. The MR device may utilize the camera to capture one or more images (e.g., image data) in the field of view, process the image data, and generate motion data of the subject's movements, including motion data associated with at least one intact limb of the subject. The MR device may comprise, or be in communication with a display, which may be any display device, such as a head-mounted device (HMD), smartphone, smart mirror, monitor, and/or television. The display may output a personalized humanoid avatar of the subject within the virtual environment. The personalized humanoid avatar may include an intact representation of an amputated limb of the subject, wherein the intact representation is a simulated limb that may mimic the motion of an intact limb. The display may output a user interface that includes a gaming session control menu. The gaming session control menu may include an option to provide a game to engage the user to move at least one intact extremity. The MR device may receive the motion data generated by the imaging device, while the subject is interacting with the game, and apply the motion data to the personalized humanoid avatar in order to cause the simulated limb of the avatar to move according to the motion data of the at least one intact limb. Lastly, the MR device may determine user feedback based on the motion data of the user and send the user feedback to a server. The user feedback may be associated with each user in order to improve the quality of the subject's experience during the entire process.

The camera may require a calibration in order to compensate for the rendering perspective of the subject interacting with the MR device. The calibration of the camera may include a real-time camera-to-skeletal pose and a real-time floor calibration to estimate a floor plane of an environment detected in the calibration data.

The MR device may further include one or more imaging devices (e.g., cameras) configured to capture images of the subject to generate the real-time 3D personalized humanoid avatar of the subject. The MR device may generate an illusion of the amputated, or missing, limb by mirroring the intact limb, simulating mirror therapy principles without constraining movements. The simulated, or virtual, limb may be generated in real-time, wherein the simulated limb may move according to the intact limb in real-time as the subject moves the intact limb.

The game output by the user interface may include a game utilizing the Mixed reality-based framework for Managing Phantom Pain (Mr. MAPP) system. The game may include an option for a first-person perspective (1PP) and an option for a third-person perspective (3PP). The first-person perspective may include a perspective wherein participants can see their 3D personalized humanoid avatar in the same manner one would see his/her own physical body from a first-person perspective. The third-person perspective may include a perspective wherein participants see their 3D personalized humanoid avatar in third-person such as how a person would see himself/herself in a mirror. The Mr. MAPP system allows multiple game levels ranging from simple games to more difficult games. The Mr. MAPP system allows for an “intelligent agent” to play against the subject. This allows a more engaging environment for the subject and may help the subject to adhere to the prescription of gaming sessions per day and for the prescribed number of days.

Depending on the MR application, one or more virtual objects of varying size, shape, orientation, color, and the like may be determined. For example, in an MR game application, a virtual object may be determined. Spatial data associated with the one or more virtual objects may be determined. The spatial data associated with the one or more virtual objects may comprise data associated with the position in 3D space (e.g., x, y, z coordinates). For a given virtual object of the one or more virtual objects, the position in 3D space may comprise a position defined by a center of mass of the virtual object and/or a position defined by one or more boundaries (e.g., outline or edge) of the virtual object. The spatial data associated with the one or more virtual objects may be registered to spatial data associated with the center of frame. Registering may refer to determining the position of a given virtual object of the one or more virtual objects relative to the position of the center of frame. Registering may also refer to the position of the virtual object relative to both the position of the center of frame and the position of the personalized avatar in the mixed reality scene. Registering the virtual object to the position of the center of frame and/or the positions of any of the one or more physical objects in the mixed reality scene results in ensuring that a display of the virtual object in the mixed reality scene is made at an appropriate scale and does not overlap (e.g., “clip”) with any of the one or more virtual objects, or the avatar, in the mixed reality scene. For example, the spatial data of the virtual object may be registered to the spatial data of the center of frame and to the spatial data of a table (e.g., one of the one or more physical objects). Such registration enables the virtual object to be displayed in the mixed reality scene so that the virtual object appears to rest on the table and does not overlap (e.g., “clip”) the table.

Movement of the MR device may cause a change in the mixed reality scene. For example, the MR device may pan, tilt, or rotate to a direction of the MR device. Such movement will impact the mixed reality scene and the personalized avatar and any virtual objects rendered therein. For example, if the MR device is tilted downward, the perspective within the virtual environment may rotate downward, akin to a person shifting his/her head downward. Likewise, if the MR device is tilted upward, the perspective within the virtual environment may rotate upward, akin to a person shifting his/her head upward. In an example, if the MR device is rotated leftward or rightward, the perspective within the virtual environment may rotate leftward or rightward, akin to a person rotating his/her head leftward or rightward.

Each of the constitutional elements described in the present document may consist of one or more components, and names thereof may vary depending on a type of an electronic device. The electronic device according to various exemplary embodiments may include at least one of the constitutional elements described in the present document. Some of the constitutional elements may be omitted, or additional other constitutional elements may be further included. Further, some of the constitutional elements of the electronic device according to various exemplary embodiments may be combined and constructed as one entity, so as to equally perform functions of corresponding constitutional elements before combination.

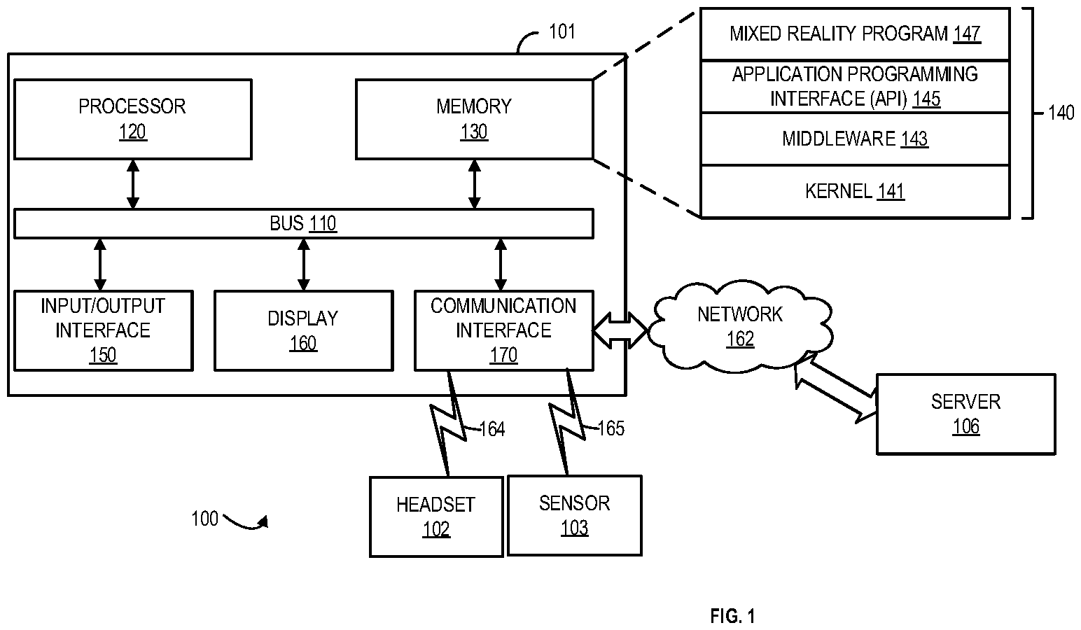

FIG. 1 shows an example system 100 including an electronic device (e.g., smartphone or laptop) configured for controlling one or more guidance systems of one or more other electronic devices (e.g., a headset device or sensor device) according to various embodiments. The system 100 may include an electronic device 101, a headset 102, one or more sensors 103, and one or more servers 106. The electronic device 101 may include a bus 110, a processor 120, a memory 130, an input/output interface 150, a display 160, and a communication interface 170. In an example, the electronic device 101 may omit at least one of the aforementioned constitutional elements or may additionally include other constitutional elements. The electronic device 101 may comprise, for example, a mobile phone, a smart phone, a tablet computer, a laptop, a desktop computer, a smartwatch, and the like.

The bus 110 may include a circuit for connecting the processor 120, the memory 130, the input/output interface 150, the display 160, and the communication interface 170 to each other and for delivering communication (e.g., a control message and/or data) between the processor 120, the memory 130, the input/output interface 150, the display 160, and the communication interface 170.

The processor 120 may include one or more of a Central Processing Unit (CPU), an Application Processor (AP), and a Communication Processor (CP). The processor 120 may control, for example, at least one of the processor 120, the memory 130, the input/output interface 150, the display 160, and the communication interface 170 of the electronic device 101 and/or may execute an arithmetic operation or data processing for communication. The processing (or controlling) operation of the processor 120 according to various embodiments is described in detail with reference to the following drawings. For example, the processor 120 may be configured to cause the headset device 102 to output a mixed reality game to the user, such as the mixed reality program 147 stored in the memory 130.

The memory 130 may include a volatile and/or non-volatile memory. The memory 130 may store, for example, a command or data related to at least one different constitutional element of the electronic device 101. In an example, the memory 130 may store a software and/or a program 140. The program 140 may include, for example, a kernel 141, a middleware 143, an Application Programming Interface (API) 145, and/or a mixed reality program (e.g., an “application”) 147, or the like, configured for controlling one or more functions of the electronic device 101 and/or an external device (e.g., the headset 102 and/or the one or more sensors 103). At least one part of the kernel 141, middleware 143, or API 145 may be referred to as an Operating System (OS). The memory 130 may include a computer-readable recording medium having a program recorded therein to perform the method according to various embodiments by the processor 120.

The kernel 141 may control or manage, for example, system resources (e.g., the bus 110, the processor 120, the memory 130, etc.) used to execute an operation or function implemented in other programs (e.g., the middleware 143, the API 145, or the mixed reality program 147). Further, the kernel 141 may provide an interface capable of controlling or managing the system resources by accessing individual constitutional elements of the electronic device 101 in the middleware 143, the API 145, or the mixed reality program 147.

The middleware 143 may perform, for example, a mediation role so that the API 145 or the mixed reality program 147 can communicate with the kernel 141 to exchange data. In addition, the middleware 143 may handle one or more task requests received from the mixed reality program 147 according to a priority. For example, the middleware 143 may assign a priority of using the system resources (e.g., the bus 110, the processor 120, or the memory 130) of the electronic device 101 to at least one of the mixed reality programs 147. For example, the middleware 143 may process the one or more task requests according to the priority assigned to the at least one of the application programs, and thus, may perform scheduling or load balancing on the one or more task requests.

The API 145 may include at least one interface or function (e.g., instruction), for example, for file control, window control, video processing, or character control, as an interface capable of controlling a function provided by the mixed reality program 147 in the kernel 141 or the middleware 143.

The mixed reality program 147 may comprise a mixed reality game output to the subject to engage the subject to move at least one intact extremity. The game output to the subject may include a game utilizing a Mixed reality-based framework for Managing Phantom Pain (Mr. MAPP) system. The game may include an option for a first-person perspective (1PP) and an option for a third-person perspective (3PP). The first-person perspective may include a perspective wherein participants can see their 3D personalized humanoid avatar in the same manner one would see his/her own physical body from a first-person perspective. The third-person perspective may include a perspective wherein participants see their 3D personalized humanoid avatar in third-person such as how a person would see himself/herself in a mirror. The Mr. MAPP system allows multiple game levels ranging from simple games to more difficult games. The Mr. MAPP system allows for an “intelligent agent” to play against the subject. This allows a more engaging environment for the subject and may help the subject to adhere to a prescription of gaming sessions per day and for a prescribed number of days. The electronic device 101 may receive motion data from the sensor 103, while the subject is interacting with the game, and apply the motion data to a personalized humanoid avatar that may be output to the subject via the headset 102.

The input/output interface 150 may be configured as an interface for delivering an instruction or data input from a user or a different external device(s) to the different constitutional elements of the electronic device 101. Further, the input/output interface 150 may output an instruction or data received from the different constitutional element(s) of the electronic device 101 to the different external device.

The display 160 may include various types of displays, such as a Liquid Crystal Display (LCD) display, a Light Emitting Diode (LED) display, an Organic Light-Emitting Diode (OLED) display, a MicroElectroMechanical Systems (MEMS) display, or an electronic paper display, for example. The display 160 may display, for example, a variety of contents (e.g., text, image, video, icon, symbol, etc.) to the user. The display 160 may include a touch screen. For example, the display 160 may receive a touch, gesture, proximity, or hovering input by using a stylus pen or a part of a subject's, or user's, body.

The communication interface 170 may establish, for example, communication between the electronic device 101 and an external device (e.g., a headset 102, a sensor device 103, or a server 106). In an example, the communication interface 170 may communicate with the external device (e.g., the server 106) by being connected to a network 162 through wireless communication or wired communication. In an example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication may include, for example, a near-distance communication 164, 165. The near-distance communications 164, 165 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Universal Serial Bus (USB), High Definition Multimedia Interface (HDMI), Recommended Standard-232 (RS-232), power-line communication, Plain Old Telephone Service (POTS), and the like. The network 162 may include, for example, at least one of a telecommunications network, a computer network (e.g., LAN or WAN), the internet, and a telephone network.

The headset 102 may comprise a head-mounted display (HMD) device that may include an optical element that may selectably turn on or off a view of an outside environment in front of a person's eyes. In an example, the headset 102 may be configured to execute the mixed reality program 147. In an example, the processor 120 may be configured to cause the headset 102 to execute the mixed reality program 147. For example, the headset 102 may be configured to output the game to the user via a user interface. Using the various sensors and modules, the headset 102 may perform a real-time camera-to-skeletal pose and a real-time floor calibration to estimate a floor plane of an environment detected in the initial data. For example, the subject may adjust his/her position to interact with virtual objects in order to calibrate the sensors and/or headset 102. Based on the calibration, the headset 102 may output a personalized humanoid avatar of the subject within an environment. In an example, the headset 102 may comprise a smart mirror instead of a headset device. The smart mirror may be configured to display a mirror representation of the subject, or the personalized humanoid avatar.

In an example, the headset 102 may use the various sensor devices and modules to detect objects or obstacles in front of the subject as the subject is performing the game via the headset 102. The headset 102 may be configured to alert the subject of any potential objects that may pose a safety risk to the subject while the subject is performing the movements while playing the game using the headset 102. For example, objects such as pets or people could pose a safety issue as they come within the distance of the subject's movements. The headset 102 may be configured to use an object detection module for detecting objects (e.g., pets, people, etc.) within a radius of the headset 102. When the object (e.g., pet, person, etc.) moves into a field of view of a sensor of the headset 102, an alarm may be trigger to alert the subject of the object. For example, the headset 102 may output a pop-up panel within the image stream and a detection result. In an example, a predicted bounding box may be output identifying the object relative to the subject in the image stream output by the headset 102 to the subject.

The sensor device 103 may comprise one or more imaging, or image, capture devices such as one or more RGB-D cameras (e.g., one or more Kinect cameras). The sensor device 103 may use a combination of sensors (e.g., the one or more sensors) to identify the subject, including the subject's amputated limb, and provide information associated with the identified subject to the electronic device 101. The sensor device 103 may also be used to detect motion data associated with the subject and provide the motion data to the electronic device 101. In an example, the electronic device 101 may perform the calibrations for the virtual environment based on receiving the calibration data from the sensor device 103.

In an example, the sensor device 103 may be configured to detect objects or obstacles in front of the subject as the subject is performing the game via the headset 102. The sensor device 103 may be configured to alert the subject of any potential objects that may pose a safety risk to the subject while the subject is performing the movements while playing the game using the headset 102. For example, objects such as pets or people could pose a safety issue while the subject is performing one or more movements (e.g., moving the lower limbs) while using the headset 102. For example, the objects may be invisible to the sensors of the headset 102. Thus, the headset 102 may have difficulty detecting any potential hazardous objects that come within range of the subject's movements while the subject is using the headset 102. The sensor device 103 may be configured to use an object detection module for detecting objects (e.g., pets, people, etc.) within a radius of the headset 102. For example, when the object (e.g., pet, person, etc.) moves into a field of view of the sensor device 103, an alarm may be trigger to alert the subject of the object. For example, the headset 102 may output a pop-up panel within the image stream and a detection result. In an example, a predicted bounding box may be output identifying the object relative to the subject in the image stream output by the headset 102 to the subject.

The server 106 may include a group of one or more servers. In an example, all or some of the operations executed by the electronic device 101 may be executed in a different one or a plurality of electronic devices (e.g., the headset 102, the sensor device 103, or the server 106). In an example, if the electronic device 101 needs to perform a certain function or service either automatically or based on a request, the electronic device 101 may request at least some parts of functions related thereto alternatively or additionally to a different electronic device (e.g., the headset 102, the sensor device 103, or the server 106) instead of executing the function or the service autonomously. The different electronic devices (e.g., the headset 102, the sensor device 103, or the server 106) may execute the requested function or additional function, and may deliver a result thereof to the electronic device 101. The electronic device 101 may provide the requested function or service either directly or by additionally processing the received result. In an example, a cloud computing, distributed computing, or client-server computing technique may be used. For example, the electronic device 101 may provide the calibration data received from the sensor device 103 to the server 106, wherein the server 106 may perform the calibration operations and return the results to the electronic device 101.

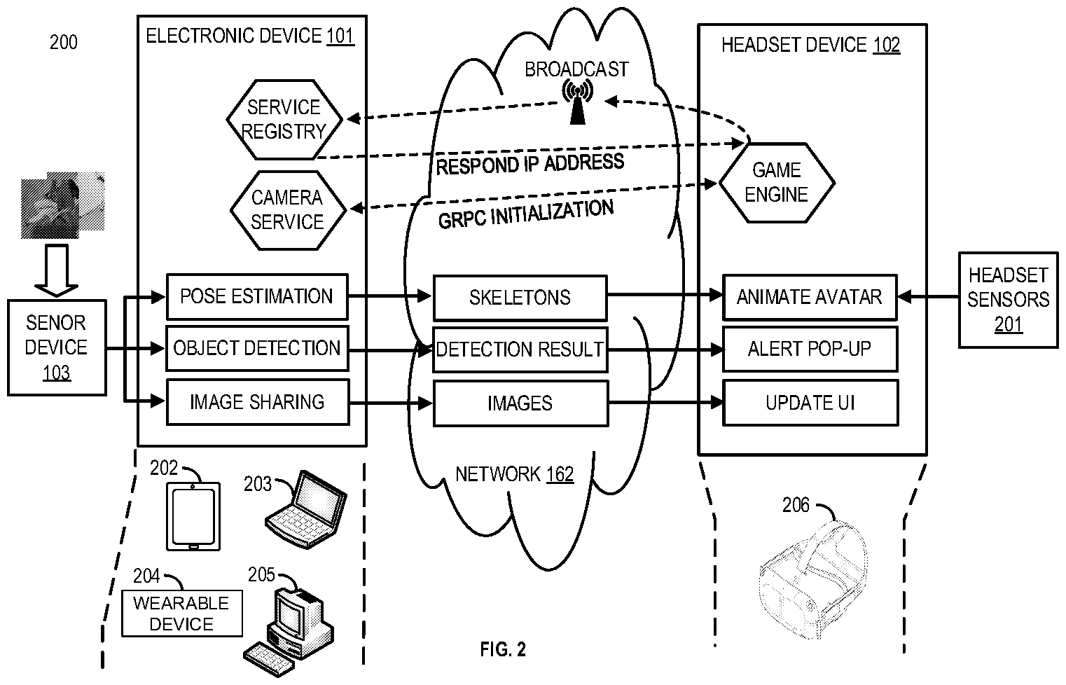

FIG. 2 shows an example system architecture 200. As shown in FIG. 2, the system architecture 200 may comprise a distributed architecture that may comprise three main components. For example, the system architecture 200 may comprise an electronic device 101, a headset device 102 (e.g., head-mounted displace device), and a wireless network 162. The electronic device 101 may comprise one or more of a tablet or mobile device 202, a laptop 203, a wearable device 204, or a desktop 205. The electronic device 101 may be configured to implement a camera service that runs a heavy GPU-based computation for motion capture and a lightweight object (e.g., pet, person, etc.) detection for safety alarms. The camera service may be configured to utilize threads serving as producers and consumers for processing to be pipelined in parallel. A producer thread may be dedicated to retrieving color and depth image data from the sensor device 103 (e.g., camera, image capture device, motion capture device, etc.) and publishing the address of the retrieved data block with subscribed consumers. The camera service may be configured to include one or more subscribed consumer threads for supplying the streaming data. In an example, the camera service may be configured to determine a pose estimation based on the imaging data received from the sensor device 103. For example, the camera service may be configured to implement a body tracking model for each frame received from the sensor device 103 and wrap up the resulting pose. The estimated pose may be used as a source to drive a subject's avatar's lower limb. As an example, the body tracking model/function may also be configured to determine a number of people captured in the scene in front of the sensor device 103. In an example, the camera service may be configured to detect one or more objects (e.g., pets, people, etc.) that come within the field of view of the camera device 103. Images received from the sensor device 103 may be preprocessed and inferences may be made once per five frames to avoid potential resource competition with the pose estimation thread. In an example, the camera service may be configure to allow image sharing, such as with the headset device 102 in order to update a user interface of the headset device 102.

The headset device 102 may comprise a head-mount device 206. The headset device 102 may be configured to implement a game engine that runs an exergame that may be used to engage a subject to perform various movements while playing the exergame. In addition, the game engine may request the data stream from the electronic device 101 on demand. For example, the game engine may be configured to exchange message streaming from the game engine to reduce network traffic. For example, images may be streamed when users need to check the sensor device's 103 field of view or the position of a detected object (e.g., pet, person, etc.). Once an object is detected other than the subject using the headset device 102, the headset device 102 may output a message (e.g., alarm, notification, alert, etc.). In an example, an alert panel may pop up in the headset set device 102 to display the captured result. In an example, if no object is detected, the subject may turn off, or deactivate, the object detection to gain a slight margin of computing performance. The estimated pose stream may be used to animate a subject's avatar. Due to the frame rate difference between the skeleton estimation and game rendering, joint rotation between frames may be interpolated for smooth animation rendering. In an example, the headset device 102 may include inertial measurement unit (IMU) sensors. Data from the IMU sensors may be integrated with the skeletal information determined from the image stream received from the sensor device 103 to reduce movement latency.

The electronic device 101 and the headset 102 may be configured to communicate with each other via the wireless network 162. The game engine may be configured to locate the camera service's internet protocol (IP) address via the wireless network 162. Without manual configuration (such as the IP address), the distributed architecture may introduce difficulty in locating the camera service from the game engine, or game rendering processor. In an example, the headset device 102 may be configured to implement a service registry for monitoring the wireless network 162 to locate the camera service's IP address (e.g., the electronic device's 101 IP address) in the wireless network 162. For example, if the game engine and the camera service are on the same local area network (LAN) (e.g., wireless network 162), the game engine may be configured to automatically discover the target (e.g., camera service) by broadcasting a query for the IP address. The camera service may respond to the service registry's query broadcast with its IP address. In an example, users may be allowed to switch between the electronic device 101 and the headset device 102 for playing the exergame without having to reset the target address. In an example, the connection bridging the camera service and the game engine via wireless network 162 may be implemented using a gRPC framework. For example, once the gRPC service interface is defined, the corresponding templates for implementing those function calls may be generated accordingly. In addition, the data streaming through the gRPC may be a compact representation of structured bytes to achieve high network communication performance.

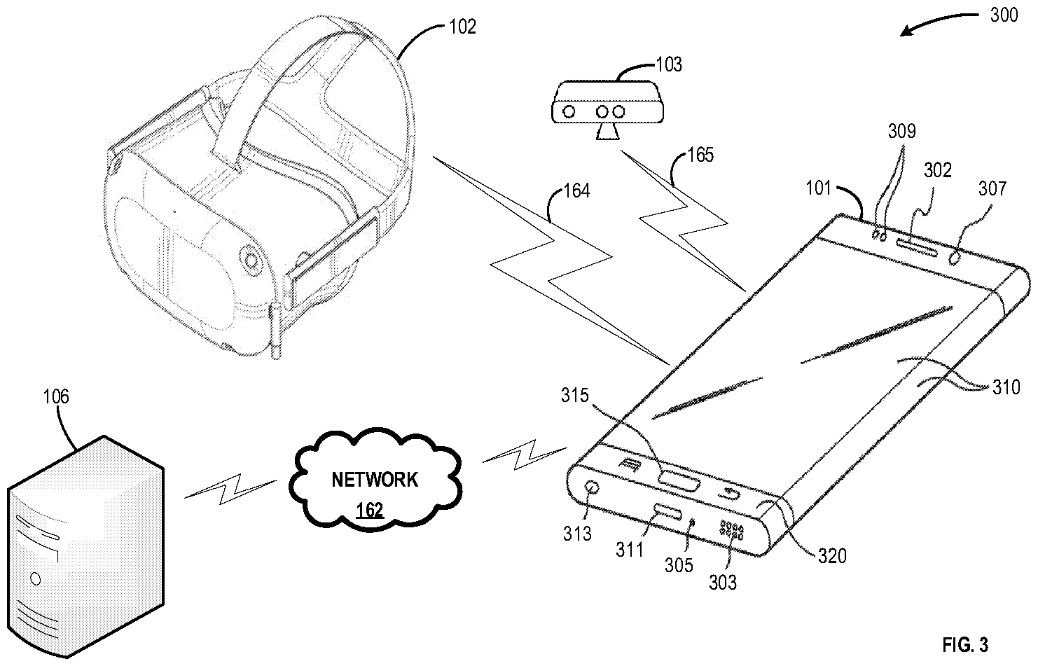

FIG. 3 shows an example system 300. The system 300 may comprise various components which may be in communication with some or other or all components. FIG. 3 shows an example system 300 wherein the electronic device 101 is in communication with the headset 102, the sensor device 103, and the server 106. The electronic device 101, and the headset 102 and the sensor device 103 may be communicatively coupled through a near field communication technology 164, 165, for example Bluetooth Low Energy or WiFi. The electronic device 101 may be communicatively coupled to the server 106 through the network 162. The electronic device 101 may determine location information. For example, the electronic device 101 may comprise a GPS sensor. The GPS sensor on the electronic device 101 may determine location information (e.g., GPS coordinates) and transmit the location information to the server 106.

The headset 102 may send data to the electronic device 101. The electronic device 101 may determine, via various sensors, image data, geographic data, orientation data and the like. The electronic device 101 may further transmit said data to the server 106.

For example, the system 300 may comprise the electronic device 101, the headset 102, the sensor device 103, and the server 106. The electronic device 101 and the headset 102 may be communicatively coupled to the server 106 VIA the network 162. In an example, the electronic device 101 may include a display 310, a housing (or a body) 320 to which the display 310 is coupled while the display 310 is seated therein, and an additional device formed on the housing 320 to perform the function of the electronic device 101. In an example, the additional device may include a first speaker 302, a second speaker 303, a microphone 305, sensors (for example, a front camera module 307, a rear camera module, and an illumination sensor 309, or the like), communication interfaces (for example, a charging or data input/output port 311 and an audio input/output port 313), and a button 315. In an example, when the electronic device 101 and the headset 102 are connected via a wired communication scheme, the electronic device 101 and the headset 102 may be connected based on at least some ports (for example, the data input/output port 311) of the communication interfaces.

In an example, the display 310 may include a flat display or a bended display (or a curved display) which can be folded or bent through a paper-thin or flexible substrate without damage. The bended display may be coupled to a housing 320 to remain in a bent form. In an example, the mobile device 301 may be implemented as a display device, which can be quite freely folded and unfolded such as a flexible display, including the bended display. In an example, in a Liquid Crystal Display (LCD), a Light Emitting Diode (LED) display, an Organic LED (OLED) display, or an Active Matrix OLED (AMOLED) display, the display 310 may replace a glass substrate surrounding liquid crystal with a plastic film to assign flexibility to be folded and unfolded.

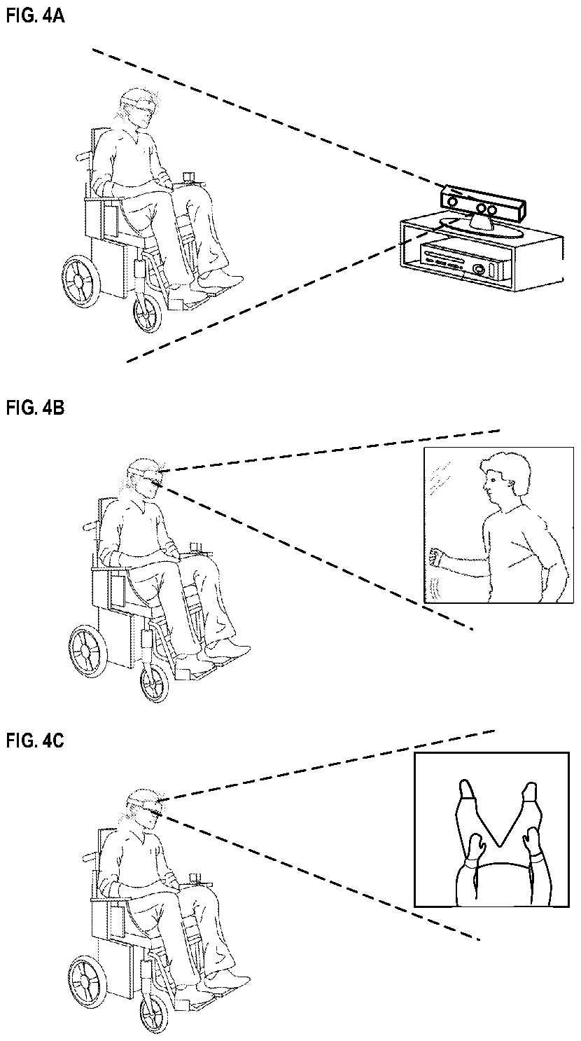

FIGS. 4A-4C show an example scenario. FIG. 4A shows a real-world scene with the subject that would be captured by the sensor device 103. As shown in FIG. 4A, the subject's left arm has been amputated. FIGS. 4B and 4C show the mixed reality scene (e.g. environment) with a personalized humanoid avatar of the subject captured by the sensor device 103. As shown in FIGS. 4B and 4C, the subject may experience the mixed reality scene through the use of a headset device. FIG. 4B shows the subject experiencing a third-person mirror perspective of the personalized avatar in a scenario wherein the subject chooses to interact with a third-person perspective of the personalized avatar. FIG. 4C shows the subject experiencing a first-person perspective of the personalized avatar in a scenario wherein the subject chooses to interact with a first-person perspective of the personalized avatar. Furthermore, as shown in FIGS. 4B and 4C, the personalized avatar includes an intact representation (e.g. simulated limb) of the amputated limb captured in FIG. 4A. The sensor device 103 may generate motion data associated with the movements of the subject. The motion data may include motion data associated with at least one of the subject's intact limbs. The motion data associated with the subject's intact limb may be applied to the simulated limb, causing the simulated limb to move according to the motion data associated with the intact limb.

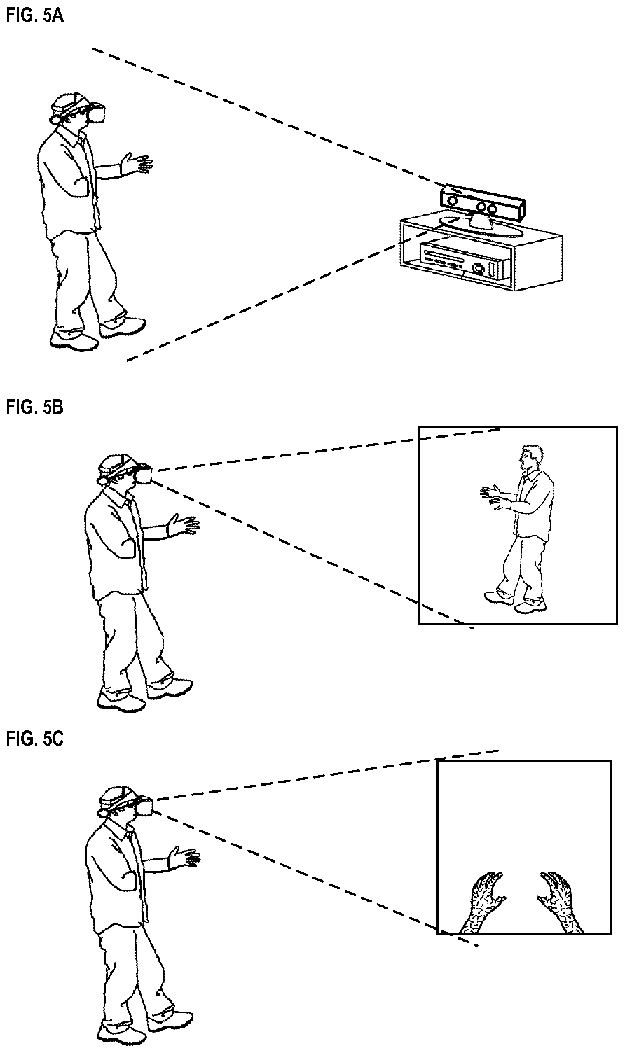

FIGS. 5A-5C show an example scenario. FIG. 5A shows a real-world scene with the subject, standing up, that would be captured by the sensor device 103. As shown in FIG. 5A, the subject's right arm has been amputated. FIGS. 5B and 5C show the mixed reality scene (e.g. environment) with a personalized humanoid avatar of the subject captured by the sensor device 103. As shown in FIGS. 5B and 5C, the subject may experience the mixed reality scene through the use of a headset device. FIG. 5B shows the subject experiencing a third-person mirror perspective of the personalized avatar in a scenario wherein the subject chooses to interact with a third-person perspective of the personalized avatar. FIG. 5C shows the subject experiencing a first-person perspective of the personalized avatar in a scenario wherein the subject chooses to interact with a first-person perspective of the personalized avatar. Furthermore, as shown in FIGS. 5B and 5C, the personalized avatar includes an intact representation (e.g. simulated limb) of the amputated limb captured in FIG. 5A. The sensor device 103 may generate motion data associated with the movements of the subject. The motion data may include motion data associated with at least one of the subject's intact limbs. The motion data associated with the subject's intact limb may be applied to the simulated limb, causing the simulated limb to move according to the motion data associated with the intact limb.

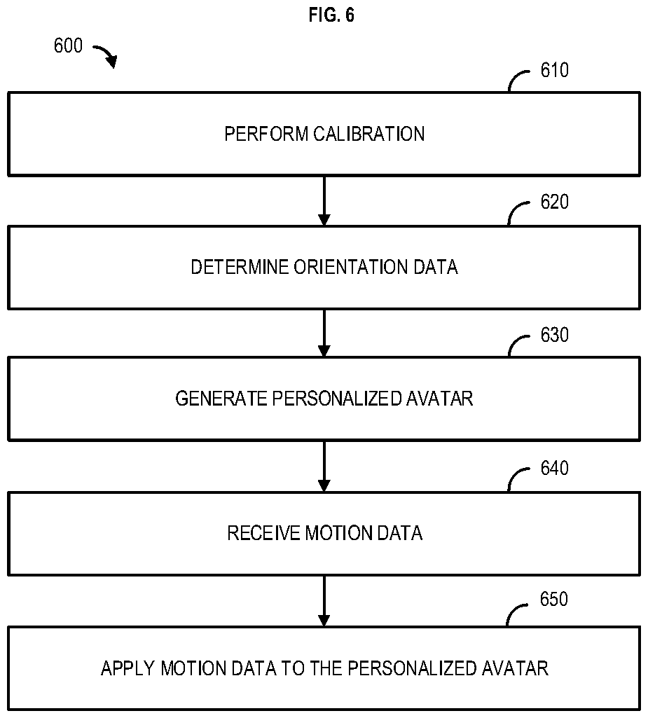

FIG. 6 shows a flow chart of an example method 600. The method 600 may be implemented in whole or in part, by one or more of, the electronic device 101, the headset 102, the sensor device 103, the server 106, or any other suitable device. At step 610, a calibration may be performed to estimate the floor plane for calibrating coordinates between the front of the sensor device 101 and the virtual environment if the skeletal joints of the user are fully detected. Using the various sensors and modules, the headset may perform a real-time camera-to-skeletal pose and a real-time floor calibration to estimate the floor plane of the environment detected in the initial data. For calibration purposes, it is assumed that the subject is standing or sitting in a vertical posture. This assumption implies that the estimated joints corresponding to the spine are distributed about a vertical trend. Thus, this vertical trend may be used as floor normal for floor calibration. Furthermore, to ensure that the target subject stays in a normal sitting or standing pose during calibration, the system may also track the shoulder height and knee angle. In an example, the subject may adjust his/her position to interact with virtual objects in order to calibrate the sensors and/or headset 102.

At step 620, orientation data may be determined. The orientation data may be associated with the headset 102. The orientation data may comprise an indication of a 3D orientation of the headset 102. The orientation data may be determined based on the location of the center of the field of view of the headset 102. The orientation data may comprise an indication of a 3D orientation of the device (e.g., yaw, pitch, roll and the like), In an example, the orientation data may be determined by a sensor module included in the headset 102, such as a magnetic sensor, gyro sensor, accelerometer, or any combination thereof. In an example, the orientation may be determined based on data received by the sensor device 103. In an example, the orientation data may be associated with a smart mirror instead of a headset 102.

At step 630, the electronic device 101 may generate a personalized humanoid avatar that may be output within the virtual environment displayed by the headset 102. The personalized humanoid avatar may include an intact (simulated) representation of the amputated, or missing, limb as shown in FIGS. 4B. 4C, 5B, and 5C. For example, the intact (e.g., counterpart) limb of the subject may be mirrored in order to create an illusion of the missing limb. The mirror process may include creating the missing skeletal joints and the associated texture information. The user interface may include an option for the subject to view a third-person perspective of the personalized avatar or a first-person perspective of the personalized avatar, as shown in FIGS. 4B, 4C. 5B, and 5C.

At step 640, the electronic device 101 may receive motion data from the sensor device 102. The sensor device 103 may comprise a RGB-D camera for capturing images of the subject. Based on the captured images, the sensor device 102 may generate motion data, including motion data associated with at least one intact limb.

At step 650, the electronic device 101 may apply motion data to the personalized humanoid avatar. Thus, the electronic device 101 may cause the personalized avatar, output by the headset 102, to perform movements according to the movements captured by the sensor device 103 in real-time as the subject moves. The motion data of the at least one intact limb may be applied to the simulated limb, causing the simulated limb to move according to the at least one intact limb, as shown in FIGS. 4B, 4C, 5B, and 5C.

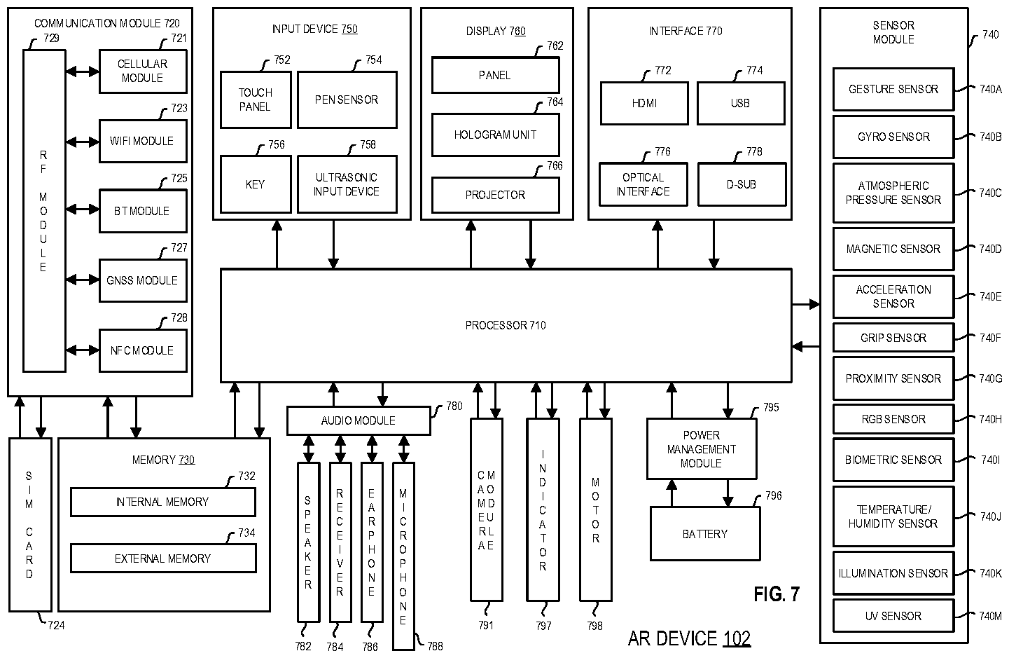

FIG. 7 shows a block diagram of a headset device 102 according to various exemplary embodiments. The headset device 102 may include one or more processors (e.g., Application Processors (APs)) 710, a communication module 720, a subscriber identity module 724, a memory 730, a sensor module 740, an input unit 750, a display 760, an interface 770, an audio module 780, a camera module 791, a power management module 795, a battery 796, an indicator 797, and a motor 798. Camera module 791 may comprise an aperture configured for a change in focus.

The processor 710 may control a plurality of hardware or software constitutional elements connected to the processor 710 by driving, for example, an operating system or an application program, and may process a variety of data including multimedia data and may perform an arithmetic operation (for example, distance calculations). For example, the processor 710 may be configured to generate a personalized humanoid avatar of the subject and place the personalized humanoid avatar within a mixed reality scene, for example the mixed reality scene shown in FIGS. 4B, 4C, 5B, and 5C. The processor 710 may be implemented, for example, with a System on Chip (SoC). In an example, the processor 710 may include a Graphic Processing Unit (GPU) and/or an Image Signal Processor (ISP). The processor 710 may include at least one part (e.g., a cellular module 721) of the aforementioned constitutional elements of FIG. 7. The processor 710 may process an instruction or data, for example the mixed reality program 147, which may be received from at least one of different constitutional elements (e.g., a non-volatile memory), by loading it to a volatile memory and may store a variety of data in the non-volatile memory. The processor may receive inputs such as sensor readings and execute the augmented reality program 147 accordingly by, for example, adjusting the position of the virtual object within the augmented reality scene. For example, the processor 710 might adjust the position and the orientation of the personalized humanoid avatar within the virtual environment.

The communication module 720 may include, for example, the cellular module 721, a Wi-Fi module 723, a BlueTooth (BT) module 725, a GNSS module 727 (e.g., a GPS module, a Glonass module, a Beidou module, or a Galileo module), a Near Field Communication (NFC) module 728, and a Radio Frequency (RF) module 729. The communication module may receive data from the electronic device 101, the sensor device 103, and/or the server 106. The communication module may transmit data to the electronic device 101 and/or the server 106. In an exemplary configuration, the headset device 102 may transmit data determined by the sensor module 740 to the electronic device 101 and/or the server 106. For example, the headset device 102 may transmit, to the electronic device 101, via the BT module 725, data gathered by the sensor module 740.

The cellular module 721 may provide a voice call, a video call, a text service, an internet service, or the like, for example, through a communication network. In an example, the cellular module 721 may identify and authenticate the headset device 102 in the network 162 by using the subscriber identity module (e.g., a Subscriber Identity Module (SIM) card) 724. In an example, the cellular module 721 may perform at least some functions that can be provided by the processor 710. In an example, the cellular module 721 may include a Communication Processor (CP).

Each of the WiFi module 723, the BT module 725, the GNSS module 727, or the NFC module 728 may include, for example, a processor for processing data transmitted/received via a corresponding module. In an example, at least some (e.g., two or more) of the cellular module 721, the WiFi module 723, the BT module 725, the GPS module 727, and the NFC module 728 may be included in one Integrated Chip (IC) or IC package. The GPS module 727 may communicate via network 162 with the electronic device 101, the server 106, or some other location data service to determine location information, for example GPS coordinates.

The RF module 729 may transmit/receive, for example, a communication signal (e.g., a Radio Frequency (RF) signal). The headset device 102 may transmit and receive data from the mobile device via the RF module 729. Likewise, the headset device 102 may transmit and receive data from the server 106 via the RF module 729. The RF module may transmit a request for location information to the server 106. The RF module 729 may include, for example, a transceiver, a Power Amp Module (PAM), a frequency filter, a Low Noise Amplifier (LNA), an antenna, or the like. According to another exemplary embodiment, at least one of the cellular module 721, the WiFi module 723, the BT module 725, the GPS module 727, and the NFC module 728 may transmit/receive an RF signal via a separate RF module.

The subscriber identity module 724 may include, for example, a card including the subscriber identity module and/or an embedded SIM, and may include unique identification information (e.g., an Integrated Circuit Card IDentifier (ICCID)) or subscriber information (e.g., an International Mobile Subscriber Identity (IMSI)).

The memory 730 (e.g., the memory 130) may include, for example, an internal memory 732 or an external memory 734. The internal memory 732 may include, for example, at least one of a volatile memory (e.g., a Dynamic RAM (DRAM), a Static RAM (SRAM), a Synchronous Dynamic RAM (SDRAM), etc.) and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory, a NOR flash memory, etc.), a hard drive, or a Solid State Drive (SSD)).

In an example, the external memory 734 may include a flash drive, for example, Compact Flash (CF), Secure Digital (SD), Micro Secure Digital (Micro-SD), Mini Secure digital (Mini-SD), extreme Digital (xD), memory stick, or the like. The external memory 734 may be operatively and/or physically connected to the headset device 102 via various interfaces.

The sensor module 740 may measure, for example, a physical quantity or detect an operational status of the headset device 102, and may convert the measured or detected information into an electric signal. The sensor module 740 may include, for example, at least one of a gesture sensor 740A, a gyro sensor 740B, a pressure sensor 740C, a magnetic sensor 740D, an acceleration sensor 740E, a grip sensor 740F, a proximity sensor 740G, a color sensor 740H (e.g., a Red, Green, Blue (RGB) sensor), a bio sensor 740I, a temperature/humidity sensor 740J, an illumination sensor 740K, an Ultra Violet (UV) sensor 740M, an ultrasonic sensor 740N, and an optical sensor 740P. Proximity sensor 740G may comprise LIDAR, radar, sonar, time-of-flight, infrared or other proximity sensing technologies. The gesture sensor 740A may determine a gesture associated with the headset device 102. For example, as the headset device 102 moves within the mixed reality scene, the headset device 102 may move in a particular way so as to execute, for example, a game action. The gyro sensor 740B may be configured to determine a manipulation of the headset device 102 in space, for example when the headset device 102 is located on a user's head, the gyro sensor 740B may determine the user has rotated the user's head a certain number of degrees. Accordingly, the gyro sensor 740B may communicate a degree of rotation to the processor 710 so as to adjust the mixed reality scene by the certain number of degrees and accordingly maintaining the position of, for example, the personalized avatar, or a virtual object, as rendered within the mixed reality scene. The proximity sensor 740G may be configured to use sonar, radar, LIDAR, or any other suitable means to determine a proximity between the headset device and one or more physical objects. The ultrasonic sensor 740N may also be likewise configured to employ sonar, radar, LIDAR, time of flight, and the like to determine a distance. The ultrasonic sensor may emit and receive acoustic signals and convert the acoustic signals into electrical signal data. The electrical signal data may be communicated to the processor 710 and used to determine any of the image data, spatial data, or the like. In an example, the optical sensor 740P may detect ambient light and/or light reflected by an external object (e.g., a user's finger, etc.), and which is converted into a specific wavelength band by means of a light converting member. Additionally or alternatively, the sensor module 740 may include, for example, an E-nose sensor, an ElectroMyoGraphy (EMG) sensor, an ElectroEncephaloGram (EEG) sensor, an ElectroCardioGram (ECG) sensor, an Infrared (IR) sensor, an iris sensor, and/or a fingerprint sensor. The sensor module 740 may further include a control circuit for controlling at least one or more sensors included therein. In a certain exemplary embodiment, the headset device 102 may further include a processor configured to control the sensor module 704 either separately or as one part of the processor 710, and may control the sensor module 740 while the processor 710 is in a sleep state.

The input device 750 may include, for example, a touch panel 752, a (digital) pen sensor 754, a key 756, or an ultrasonic input device 758. The touch panel 752 may recognize a touch input, for example, by using at least one of an electrostatic type, a pressure-sensitive type, and an ultrasonic type. In addition, the touch panel 752 may further include a control circuit. The touch panel 752 may further include a tactile layer and thus may provide the user with a tactile reaction.

The (digital) pen sensor 754 may be, for example, one part of a touch panel, or may include an additional sheet for recognition. The key 756 may be, for example, a physical button, an optical key, a keypad, or a touch key. The ultrasonic input device 758 may detect an ultrasonic wave generated from an input means through a microphone (e.g., a microphone 1088) to confirm data corresponding to the detected ultrasonic wave.

The display 760 (e.g., the display 760) may include a panel 762, a hologram unit 764, or a projector 766. The panel 762 may include a structure the same as or similar to the display 310 of FIG. 3. The panel 762 may be implemented, for example, in a flexible, transparent, or wearable manner. The panel 762 may be constructed as one module with the touch panel 752. In an example, the panel 762 may include a pressure sensor (or a force sensor) capable of measuring strength of pressure for a user's touch. The pressure sensor may be implemented in an integral form with respect to the touch panel 752, or may be implemented as one or more sensors separated from the touch panel 752.

The hologram unit 764 may use an interference of light and show a stereoscopic image in the air. The projector 766 may display an image by projecting a light beam onto a screen. The screen may be located, for example, inside or outside the headset device 102. According to one exemplary embodiment, the display 760 may further include a control circuit for controlling the panel 762, the hologram unit 764, or the projector 766.

The display 760 may display a real-world scene and/or the mixed reality scene. The display 760 may receive image data captured by camera module 791 from the processor 710. The display 760 may display the image data. The display 760 may display the one or more physical objects. The display 760 may display one or more virtual objects such as a virtual ball, virtual animal, virtual furniture, etc. The user may interact with the one or more virtual objects, wherein the user may adjust his/her position in the virtual environment, if necessary, and reach for the virtual objects.

The interface 770 may include, for example, a High-Definition Multimedia Interface (HDMI) 772, a Universal Serial Bus (USB) 774, an optical communication interface 776, or a D-subminiature (D-sub) 778. The interface 770 may be included, for example, in the communication interface 170 of FIG. 1. Additionally or alternatively, the interface 570 may include, for example, a Mobile High-definition Link (MHL) interface, a Secure Digital (SD)/Multi-Media Card (MMC) interface, or an Infrared Data Association (IrDA) standard interface.

The audio module 780 may bilaterally convert, for example, a sound and electric signal. At least some constitutional elements of the audio module 780 may be included in, for example, the input/output interface 150 of FIG. 1. The audio module 780 may convert sound information which is input or output, for example, through a speaker 782, a receiver 784, an earphone 786, the microphone 788, or the like.

The camera module 791 is, for example, a device for image and video capturing, and according to one exemplary embodiment, may include one or more image sensors (e.g., a front sensor or a rear sensor), a lens, an Image Signal Processor (ISP), or a flash (e.g., LED or xenon lamp). The camera module 791 may comprise a forward facing camera for capturing a scene. The camera module 791 may also comprise a rear-facing camera for capturing eye-movements or changes in gaze.

The power management module 795 may manage, for example, power of the headset device 102. In an example, the power management module 795 may include a Power Management Integrated Circuit (PMIC), a charger Integrated Circuit (IC), or a battery fuel gauge. The PMIC may have a wired and/or wireless charging type. The wireless charging type may include, for example, a magnetic resonance type, a magnetic induction type, an electromagnetic type, or the like, and may further include an additional circuit for wireless charging, for example, a coil loop, a resonant circuit, a rectifier, or the like. The battery gauge may measure, for example, residual quantity of the battery 796 and voltage, current, and temperature during charging. The battery 796 may include, for example, a rechargeable battery and/or a solar battery.

The indicator 797 may display a specific state, for example, a booting state, a message state, a charging state, or the like, of the headset device 102 or one part thereof (e.g., the processor 710). The motor 798 may convert an electric signal into a mechanical vibration, and may generate a vibration or haptic effect. Although not shown, the headset device 102 may include a processing device (e.g., a GPU) for supporting a mobile TV. The processing device for supporting the mobile TV may process media data conforming to a protocol of, for example, Digital Multimedia Broadcasting (DMB), Digital Video Broadcasting (DVB), MediaFlo™, or the like.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow: plain meaning derived from grammatical organization or punctuation: the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
causing a display, based on a calibration of a sensor, to output an avatar of a user within a virtual environment, wherein the avatar comprises an intact extremity representation of an amputated extremity of the user;
receiving, from the sensor, motion data of user movements, wherein the motion data is associated with one or more motions of at least one intact extremity; and
applying the motion data to the avatar, wherein the one or more motions of the at least one intact extremity are applied to the intact extremity representation of the amputated extremity.

2. The method of claim 1, wherein the display comprises a head mounted display (HMD).

3. The method of claim 2, wherein the HMD comprises a glass configured to one or more of selectively turn off a view of an outside environment in front of the user or selectively turn on a view of an outside environment in front of the user and output an augmented environment.

4. The method of claim 2, wherein the HMD is configured to implement a game rendering engine, wherein the game rendering engine is configured to output a game to the user independently from a processing device configured to process the motion data received from the sensor.

5. The method of claim 4, wherein the game rendering engine is further configured to launch a service registry for locating the processing device on a network.

6. The method of claim 1, wherein the at least one intact extremity comprises at least one intact limb, and wherein the intact extremity representation of the amputated extremity comprises an intact limb representation of an amputated limb.

7. The method of claim 1, wherein the sensor comprises a camera.

8. The method of claim 1, wherein the display is further configured to output a game to engage the user to move the at least one intact extremity.

9. The method of claim 8, further comprising receiving user feedback during the game, wherein the user feedback is sent to a server that stores the user feedback in a database associated with the user.

10. The method of claim 1, wherein the calibration of the sensor comprises performing a real-time floor calibration based on receiving calibration data from the sensor, wherein the real-time floor calibration comprises estimating a floor plane of an environment based on the received calibration data.

11. The method of claim 1, further comprising:
determining one or more objects within a radius of the user; and
causing the display to output an alert of the one or more objects within the radius of the user.

12. An apparatus comprising:
one or more processors; and
a memory storing processor-executable instructions that, when executed by the one or more processors, cause the apparatus to:
cause a display, based on a calibration of a sensor, to output an avatar of a user within a virtual environment, wherein the avatar comprises an intact extremity representation of an amputated extremity of the user;
receive, from the sensor, motion data of user movements, wherein the motion data is associated with one or more motions of at least one intact extremity; and
apply the motion data to the avatar, wherein the one or more motions of the at least one intact extremity are applied to the intact extremity representation of the amputated extremity.

13. The apparatus of claim 12, wherein the display comprises a head mounted display (HMD).

14. The apparatus of claim 13, wherein the HMD comprises a glass configured to one or more of selectively turn off a view of an outside environment in front of the user or selectively turn on a view of an outside environment in front of the user and output an augmented environment.

15. The apparatus of claim 13, wherein the HMD is configured to implement a game rendering engine, wherein the game rendering engine is configured to output a game to the user independently from a processing device configured to process the motion data received from the sensor.

16. The apparatus of claim 15, wherein the game rendering engine is further configured to launch a service registry for locating the processing device on a network.

17. The apparatus of claim 12, wherein the at least one intact extremity comprises at least one intact limb, and wherein the intact extremity representation of the amputated extremity comprises an intact limb representation of an amputated limb.

18. The apparatus of claim 12, wherein the sensor comprises a camera.

19. The apparatus of claim 12, wherein the display is further configured to output a game to engage the user to move the at least one intact extremity.

20. The apparatus of claim 19, wherein the memory storing processor-executable instructions that, when executed by the one or more processors, is further configured to cause the apparatus to receive user feedback during the game, wherein the user feedback is sent to a server that stores the user feedback in a database associated with the user.

21. The apparatus of claim 12, wherein the calibration of the sensor comprises performing a real-time floor calibration based on receiving calibration data from the sensor, wherein the real-time floor calibration comprises estimating a floor plane of an environment based on the received calibration data.

22. The apparatus of claim 12, wherein the memory storing processor-executable instructions that, when executed by the one or more processors, is further configured to:
determine one or more objects within a radius of the user; and
cause the display to output an alert of the one or more objects within the radius of the user.
